(19) United States
(12) Patent Application Publication
(10) Pub. No.: US 2010/0239111 A1
(43) Pub. Date: Sep. 23, 2010

(54) HEARING INSTRUMENT HOUSING MADE OF A POLYMER METAL COMPOSITE

(75) Inventors: Erdal Karamuk, Meilen (CH); David Waeckerlin, Stafa (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/741,409

(22) PCT Filed: Nov. 9, 2007
(86) PCT No.: PCT/EP07/62161

§ 371 Date: May 5, 2010

(51) Int. Cl. H04R 25/00; B29C 45/16

(52) U.S. Cl. 381/322; 264/259

(57) ABSTRACT

A hearing aid housing consists at least partially of a housing outer surface (5) made out of metal.

The present invention refers to a process for creating a metallic appearance on hearing aid housings according claim 1.

The appearance of everyday life devices, such as e.g. a hearing aid becomes more and more important. While hearing aids in the past should have been more or less invisible or as discreet as possible, nowadays to stand for wearing a hearing aid becomes more and more popular, comparable e.g. with wearing glasses.

As a consequence, hearing aids must not only differ in relation to the inner life, which means in relation to technical features, but also regarding the appearance or the design. In other words, decorative elements become an important issue and consequently, quite costly finishing is applied to different hearing aids or classes of hearing aids to create the possibility of aids to be distinguishable.

To create the appearance of exclusivity and high tech appearance, the application of metallic effects is desired. Besides applying metallic lacquers, different processes are employed to achieve a metallic appearance such as:
using metallic additives in injection molding process,
water transfer printing,
tampon printing,
hot stamping,
electro-plating
plasma deposition or PUD

From all these processes, only the two last mentioned are creating a true metallic surface, which however has to be coated with a protection lacquer due to the very weak abrasion resistance.

In addition, in the hearing aid industry, besides decorative also functional metallic coatings are known. These are used mainly to achieve electromagnetic shielding of the hearing aid and are usually applied to the interior side of the housing, meaning it cannot be recognized as a decorative element.

Further, within the WO 00/45617 A2 a hearing aid housing is proposed completely made out of titanium. The motivation for the use of a metallic housing is on one side the mechanical resistance and on the other side the shielding against electromagnetic radiation.

Within the EP 1092335, a process is described to create a very thin electrically conducting layer on the interior side of the hearing aid housing created by means of plasma deposition of metals. The DE 43 437 02 proposes a hearing aid housing made out of various parts which for protection against electromagnetic radiation are coated with an electric conducting layer either on the interior or exterior surface of the housing.

Furthermore, it is proposed to make hearing aid housings directly with metal by means of the so-called MIM (Metal injection molding) process. For that reason a metallic powder is combined with an organic binder and is processed by means of injection molding. Since the polymer matrix is later removed at high temperatures that also lead to sintering of the metal powder, relatively high shrinkage usually occurs.

The problem existing for metallic appearance at hearing aid housings are the following:

### Material Compatibility:

The process for coating a metal layer must be compatible with the usual polymers used for hearing aid housings. Electro-plating usually is only possible for ABS, while housings for hearing aids may be made out of other suitable plastics such as e.g. polyamide 11 or 12.

### Bio-Compatibility:

The surface, as usually in contact with skin, has to fulfil skin-compatibility according ISO 10993.

Corrosion-Resistance in Contact with Skin, Perspiration and Sebum:

The surface of the housing is exposed to relatively aggressive surroundings, as human perspiration has a relatively high acidity.

### High Abrasion Resistance:

The bonding of the metallic layer on the polymer substrate has to be excellent, as otherwise peeling-off or blistering of the coating may occur. Furthermore, while cleaning the hearing aid by means of a cloth in combination with organic solvents or disinfectants the coating should not be rubbed off.

### High Scratch Resistance:

The metal coating must represent a high scratch resistance, as otherwise the surface may lose the highly technical appearance which is represented by the metal coating.

### Possibility of Differentiation:

The process for the application of a metal coating should allow the use of different materials and surface qualities so that a further differentiation of the product is possible. For instance, it should be possible to process small series of very exclusive designs, e.g. representing a precious metal surface.

### Process of Very Small Series:

Compared with other applications/branches, hearing aids are produced in relatively small series (<10⁶ per year). Most of those hearing aids are still produced and sold in traditional skin colors, and only a very small amount is produced in exclusive high-tech colors or designs.

Nevertheless, due to marketing reasons, it is important and desirable also to produce smallest series representing an exclusive design to enable differentiation against competition.

As a consequence, it is an object of the present invention to create a metallic appearance of hearing aids in an easy and cost-effective manner, taking all the above requirements and problems into consideration.

According the present invention, it is proposed to use a metallic foil which is injected or die-cast with a polymer material from its backside to create a hearing aid housing with a metallic appearance.

At the injection-molding process, the metallic foil is inserted into the mold, followed by the injection step using the polymeric material.

The metallic foil is treated or coated with a primer or adhesion promoter to enhance the adherence of the polymer material to the metallic foil.

This technology, creating a metallic effect on polymer surfaces by means of back-injection or die-coating from the backside of metal foils, is known and is used mainly in the automotive industry or for the creation of household devices. For that reason a metallic foil, coated with a primer or an adhesion promoter is inserted into an injection mold and afterwards the polymer is injected into the mold. As a result, a durable compound is created, which on one side has a metal coating which according to the thickness of the used metal foil may have a thickness of up to several tenths of a millimetre, dependent on the piece to be produced. On one side of the metal foil, the polymer material is arranged, comprising the functional design of the part to be produced. By means of a very high injection pressure the metal foil is formed, which means all the various recesses, cavities or uprisings within the mold will be formed, such as e.g. geometric elements, script name-plates, patterns or textures. The result of this technology is also called “cool touch” effect, as the relatively thick metal coating does create a sensation of cold compared to a thin galvanic layer due to a higher heat dissipation.

Therefore, the basis for the present invention consists of the described known technology of back-injection or die-coating of metal foils from the back for the creation of hearing aid housings. As a consequence, many advantages can be achieved compared with existing known processes for the metallisation of hearing aid components:
Compatibility of materials: The proposed process does only have a very limited dependency on the used substrate. The bonding is achieved mostly by the respective modification of the metal foil. By using an appropriate primer or adhesion promoter also bonding to material such as polyamide 11 or 12 can be realized.
Bio compatibility: The technology enables the use of different metal foils, such as noble steel, titanium or noble metals so that excellent skin compatibility can be guaranteed.
Corrosion-resistance in contact with skin, perspiration and sebum: As mentioned above, metal foils made out of corrosion-resistant metals such as noble steel or titanium can be used so that corrosion-resistance is guaranteed.
High abrasion-resistance: As it is not a coating but a compact metal layer of up to a thickness of 100 μm or more, abrasion is no problem. The important objective consists in a good composite to the polymer substrate which can be guaranteed by use of an appropriate primer system.
High scratch-resistance: The solid metal layer represents a significantly higher scratch resistance compared to surfaces of polymers or lacquers.
Differentiation: The process enables the use of a great variety of metal foils, as long as they are available in an appropriate thickness. Therefore, it is possible to use with the same process titanium, noble steel or noble metal foil. Hence, even exclusive designs with gold or platinum foils can be achieved.
Production of small series: The back-injection of metal foils can be done theoretically within the same mold which is used for pure polymer parts, as long as a device is integrated for fixing the metal foil. As a consequence pure mold polymer parts as well as metallised surfaces can be produced.
Cost of production: The cost for the process is comparable with the production costs of lacquers as it is only based upon a manual insertion of a tailor-made metal foil. But as there are no additional investments needed for molds or other equipment this extra effort for the production of small or smallest series is certainly justified.
Mechanical properties: the mechanical properties of the housing are defined by the composition and thickness of the metal foil. A thicker metal foil certainly will create a stiffer housing, but on the other side one has to take into consideration that there is still enough room on the side of the polymer material for mechanical holding elements for the arrangement of the interior of the hearing aid. In addition the use of metallic components makes the hearing instrument heavier which is preferred to stabilize vibrations of the loudspeaker. Arranging the loudspeaker at a higher mass is preferred. In addition due to the higher stiffness the acoustic radiation is reduced due to reduced vibrations.

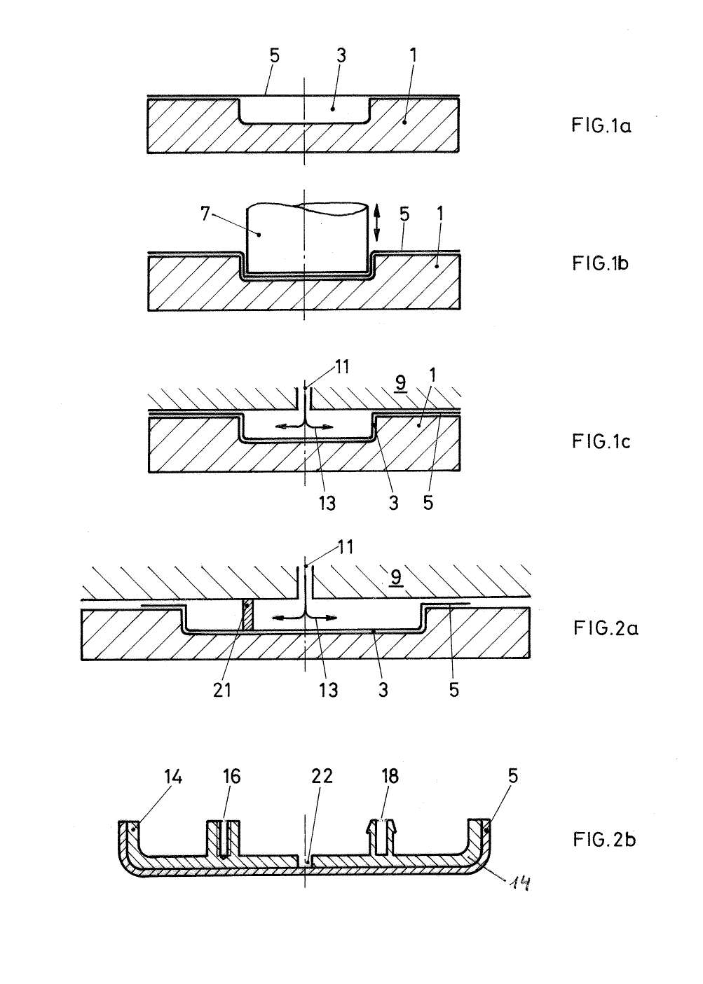

By reference to the attached figures, the very simple process shall be described in more detail.

Whereas FIG. 1a shows the mold with the tailor-made arranged metal foil before injection,

FIG. 1b shows the mold by punching in the metal foil, and

FIG. 1c shows the injection process.

FIG. 2a shows the possibility to incorporate the functionality during the injection process and

FIG. 2b shows a part of a molded hearing aid housing in sectional view after removing out of the mold.

According FIG. 1a, a mold 1 is shown, comprising a form 3 for the production of a part such as a housing of a hearing aid. Over this form 3 the metal foil 5 is arranged. Before arranging the metal foil 5, which could be e.g. a titanium foil or a foil made out of noble steel, it is treated with a primer or adherence promoter to enhance the bonding of the polymer which shall be injected at a later stage.

According one possibility, the metal foil 5 could already be punched into the form 3 by means of a specific tool 7. By having the metal foil pre-punched the forming has not to be created by the injection pressure of the polymer. In other words, a two-step process takes place by first having punched the metal foil and in the second step the polymer is injected into the form. An advantage could be that the forming of the polymer can be improved, so that the injection pressure is only responsible for the distribution of the polymer melt.

The head 9 of the injection molding machine is arranged above the form 3 of the mold 1 so that the polymer material such as e.g. polyamide 11 or polyamide 12 can be injected through the injection port 11 into the form 3. In case that the metal foil is not already punched into the form 3, it will be forced into the form 3 by the injection pressure of the polymer material, which flows along the arrows 13 into the mold form. The hearing instrument houses may be produced either batch wise by introducing a metal foil or sheet into the mold for each molding process or a metal or foil band can be transported through the mold or form in a semi-continuous process. In the latter case the sheet or foil is transported stepwise, at each step a housing of a hearing instrument is produced, the band is transported for one item, the next housing is produced, etc.

The great advantage of the inventively proposed process consists in the possibility to create new and a great variety of design, which means to produce true metal surfaces of highest quality. By means of the inventive process, a further differentiation within the product group of hearing aids is possible.

FIG. 2a shows schematically the possibility to arrange a further functionality during the injection process as described above.

On the side of the polymer material it might be desirable to arrange compact location and to create a compact electrical connection between the metal outer surface on one side and components arranged within the hearing aid on the other side. For instance, in case of a rechargeable battery arranged within the hearing aid, one possibility to recharge the battery could be to place the whole hearing aid within a respective recharging device and use the outer metallic surface as a connector. Due to the electric contact from the metal outer surface through the polymer housing wall the recharging process could take place. Or, in case of a switching operation caused by touching the outer metal surface, again the contact through the polymer housing could be responsible for the switching operation. In this case the outer metallic layer of the housing is used as an electrode, e.g. in a capacitive switch arrangement.

Accordingly, as shown in FIG. 2a, during the injection process as shown in FIG. 1c, a metal pin 21 could be inserted into the mold, around which metal pin the polymer melt would flow within the form 3. Or alternatively, instead of a metal pin 21, a hole could be created by a respective hollow pin, which again is arranged within the form 3 during the injection process of the polymer material. After release of the hearing aid housing consisting of the outer metal surface and the inner polymer material, a metal pin or a wire could be arranged within the hole created by the hollow pin 21.

In FIG. 2b a part of a hearing aid housing is shown in longitudinal sectional view after release out of the mold as shown in FIG. 2a. The housing is consisting out of the metal foil 5 and the polymer layer 14, which is arranged behind the metal layer 5. During the molding process it is possible by respective design of the mold to produce constructive elements within the polymer layer like e.g. a thread 16, a snapper 18 or other elements. In addition schematically shown in FIG. 2b is a breakout 22 within the polymer layer, which can be achieved by the inserted pin 21, as shown in FIG. 2a.

The inventive process does not need specific tools but can be executed with the same molds which are used for the production of conventional polymer housings with certain necessary modifications at the tool.

The process enables the production of very exclusive designs by using foils of noble steel, titanium or even noble metals such as gold or platinum.

1. Hearing aid housing consisting at least partially of a metallic surface.

2. Hearing aid housing according to claim 1, comprising at least partially a surface consisting of a noble steel such as titanium, stainless steel or a noble metal.

3. Hearing aid housing according to claim 1 or 2, comprising at least partially a housing wall made out of a metal/polymer composite material.

4. Housing according to claim 3, characterized in, that between the polymer and the metal layer a primer material for better bonding of the polymer to the metal surface is arranged.

5. Housing according to claims 1 to 4, characterized in that the thickness of the metal layer is at least 50 μm.

6. Process for creating a metallic appearance of hearing aid housings, characterized in that a production process of the housing injection molding technique on a metallic foil, a polymeric material is injected or die-cast from the backside of the metal foil or steel respectively.

7. Process according claim 6, characterized in that during the injection molding process the metallic foil is inserted into the mold, followed by the injection step using the polymeric material. injected or die-cast from the backside of the metal foil or steel respectively.

8. Process according claim 7, characterized in that during the injection molding process the metallic foil is inserted into the mold, followed by the injection step using the polymeric material.

9. Process according one of the claim 7 or 8, characterized in that the metal foil is treated or coated with a primer or adhesion promoter to enhance the adherence of the polymeric material to the foil.

10. Process according to one of the claims 7 to 9, characterized in that a polymeric material, polyamide 11 or 12 is used.

11. Process according to one of the claims 7 to 10, characterized in that as metal foil, noble steel, titanium or a noble metal is used such as gold or platinum.

12. Process according to one of the claims 7 to 11 characterized in that during the injection molding process a contact is created from the metal foil or metal surface through the polymeric material by either arranging an electric conductive area through the polymeric material or by creating a hole through the polymeric material provided for arranging a conductive material.

13. Hearing instrument housing being made using a process to one of the claims 7 to 12.
